(19) United States
(12) Patent Application Publication
(10) Pub. No.: US 2020/0241508 A1
(43) Pub. Date: Jul. 30, 2020

(54) Cleaning device with data acquisition unit

(71) Applicant: VERMOP Salmon GmbH, Gilching (DE)

(72) Inventors: Dirk Salmon, Gilching (DE); Robert Auer, Stadtbergen (DE)

(73) Assignee: VERMOP Salmon GmbH, Gilching (DE)

(21) Appl. No.: 16/260,685

(22) Filed: Jan. 29, 2019

(51) Int. Cl. G05B 19/4155

(52) U.S. Cl. CPC G05B 19/4155; G05B 2219/45098

(57) ABSTRACT

A cleaning device for an object to be cleaned comprises a receiving device (16) that is configured to exchange data at close range with autonomous units (30) permanently installed in the object to be cleaned and to receive data (34) from the autonomous units; a data acquisition unit (18) which is suited to acquire the data received from the receiving device (16) and to supply it in an appropriate form to a data processing unit (20), with the data processing unit (20) comprising an evaluation software for processing the supplied data. The cleaning device further comprises an output unit (22) which preferably comprises a display and particularly preferably comprises a display with a touchscreen, with the output unit being in an information connection with the data processing unit (20) and being suited to output information and/or handling instructions to the user of the cleaning device (12).

### FIELD OF THE INVENTION

The invention relates to a cleaning device with a data acquisition unit as well as a cleaning system comprising such a type of cleaning device.

### PRIOR ART

In the professional cleaning sector, questions of logistics, process planning and object control are becoming increasingly important. Cleaning processes are to be carried out more efficiently through targeted process planning.

A partial aspect is already known from EP 3 059 370 A1 in which it is proposed to equip cleaning devices with movement sensors in order to, on the one hand, train correct movement sequences and, on the other hand, to also determine the position of cleaning devices in an object to be cleaned.

There is an increasing demand for a cleaning device that can be included in an integrated cleaning concept in order to be able to plan and carry out the cleaning process more efficiently.

### SUBJECT MATTER OF THE INVENTION

The invention is based on the object of developing a cleaning device as well as a cleaning system comprising such a type of cleaning device with which the targeted process planning of cleaning processes is able to be carried out more efficiently.

This object is solved by a cleaning device having the features of claim 1 as well as a cleaning system having the features of claim 8. Preferred embodiments are apparent from the other claims.

The cleaning device according to the invention for an object to be cleaned comprises a receiving device which is suited to exchanging data at close range with autonomous units permanently installed in the object to be cleaned and for receiving data from the autonomous units. Furthermore, the cleaning device comprises a data acquisition unit that is suited to acquiring the data received from the receiving device and to supply it in a suitable form to a data processing unit, with the data processing unit comprising an evaluation software for processing the supplied data. Lastly, the cleaning device comprises an output unit which the data processing unit is in an information connection with and is adapted to output information and/or handling instructions to the user of the cleaning device.

The cleaning device is therefore specially designed to collect and evaluate data from autonomous units permanently installed in the object to be cleaned and to output information to the user of the cleaning device based on this data. As soon as the cleaning device comes into close proximity to it, a wireless data connection is established between the cleaning device and the autonomous units. The autonomous units thereby comprise a signal transmitter, a microchip as well as preferably a sensor system. If the cleaning device is at close range to a signal transmitter, data from the autonomous unit permanently installed in the object in the form of a signal transmitter can be transmitted to the cleaning device. The term “at close range” can correspond to the standardized framework conditions of near-field communication (NFC), but is not limited to these standardized framework conditions. It is decisive that the cleaning device, as soon as it comes within range of the signal transmitters, it can either receive push notifications or it can access from the autonomous unit information that can be detected and evaluated in the cleaning device.

The evaluation software for processing the supplied data is stored in an arbitrary form in a permanent or volatile memory of the data processing unit, and is preferably adapted to the object to be cleaned. In this way, an individual and optimized process planning can be carried out for an object to be cleaned, with customer-specific requirements being able to be stored in the evaluation software.

The cleaning system according to the invention comprises a cleaning device according to the invention as defined above as well as at least one autonomous unit comprising a signal transmitter, a microchip as well as preferably a sensor system.

As already described above, a communication takes place between the cleaning device and the signal transmitter of the at least one autonomous unit in the near field. Consequently, no further infrastructure is required and the object to be cleaned can be easily equipped and even retrofitted with the autonomous units having signal transmitters. In a cleaning system, a plurality of autonomous units are generally used, of which a plurality can be equipped without a sensor system, but also a plurality can also be equipped with a sensor system.

Autonomous units without sensor systems can, for example, be used to determine the position of the cleaning device in the object to be cleaned. For this purpose, the cleaning device itself must communicate with a central control device which can be used to detect the position of various cleaning devices in the object to be cleaned. Autonomous units having a sensor system are used to detect a movement or activation of certain elements in the object to be cleaned. For this purpose, the autonomous units are attached to selected elements in the object to be cleaned in order to be able to supply relevant data for the planning of the cleaning

An example of this is the number of operations of a soap dispenser, from which it can be determined when the supply of cleaning liquid contained in the soap dispenser runs out. If the cleaning device, which is preferably a cleaning trolley, comes within the range of the autonomous unit having a movement sensor permanently installed on the soap dispenser, an automatic data exchange with the receiving device of the cleaning device occurs, and the data acquisition unit forwards the number of operations to a data processing unit, the evaluation software of which stores the number of operations of the soap dispenser after which the supply of cleaning liquid is used up. If a predetermined minimum filling quantity that is stored in the evaluation software is fallen below, which can be oriented to the cleaning frequency of the object to be cleaned, the output unit delivers the handling instructions to the user of the cleaning trolley so that the user can refill the soap dispenser, whereupon the autonomous unit is reset to its original state via a reset function when the storage container has been completely filled. The reset function can occur in various ways. On the one hand, it is possible that the user activates a reset function directly on the autonomous unit. Moreover, it is also possible that the cleaning device is provided with an input device which serves the data input by the user. Lastly, it is also possible that the cleaning system further comprises a Personal Digital Assistant which is carried by the user and which exchanges data with the cleaning device and optionally also exchanges data with the autonomous unit in order to perform the system reset after corresponding input by the user that the handling instruction has been carried out.

The principle explained in detail above with regard to refilling a soap dispenser can of course be used in the same way for a plurality of other cleaning tasks. Thus, the system can be used in an analogous manner in order to service and load the coffee machines in office kitchens, or to be reminded to change the vacuum cleaner bag when carrying a vacuum cleaner.

However, the sensor system in the form of motion sensors can also be attached to doors, in particular door handles, in order to identify rooms that have not been entered. The can be meeting rooms in an office area, however also, sickrooms in a hospital that were unoccupied for a certain period of time. By omitting cleaning activities or increasing the cleaning frequency in areas where immediate cleaning is not required, the entire cleaning task can be optimized further.

Lastly, the system with motion sensors can also be used to prove to a client the quantity of consumables such as cleaning liquid or tissue cloths.

According to a preferred embodiment of the invention, the cleaning device is a cleaning trolley. A cleaning trolley is moved by the cleaning staff through the object to be cleaned and thus automatically comes within the range of the autonomous units in order to be able to exchange data with them. Moreover, it is expedient to arrange the output unit in the immediate vicinity of the user so that the cleaning person can access the necessary cleaning utensils and supplies carried by the cleaning trolley after receiving the information and/or handling instructions communicated via the output unit.

Preferably, the output unit comprises a display which is preferably designed as a touch screen and is therefore also an input device for data input by the user.

According to a preferred embodiment of the invention, the receiving device is additionally configured to exchange data with further autonomous units and to receive data from them, with the further autonomous units comprising a cleaning device. In this manner, a complex overall system can be generated that can be configured in different ways. Firstly, corresponding to the above-described preferred embodiment, a cleaning trolley can have the receiving device, data acquisition unit, data processing unit and output unit, and communicate with the autonomous units permanently installed in the object to be cleaned as well as with further autonomous units of which at least one is a cleaning unit. The cleaning device can be, for example, a mop or a vacuum cleaner, but also a further cleaning trolley, so that different cleaning trolleys can also communicate with one another. Moreover, the further autonomous unit can also be a central control unit that is superordinate to individual cleaning devices, which, for example, transmits changed schedules to the cleaning device. In contrast to the autonomous units permanently installed in the object to be cleaned, the receiving device, which only exchanges data via near-field communication, can also exchange data over longer distances.

The possible communication with a central control unit serves the purpose that a cleaner receives the information to carry certain required materials on the cleaning trolley or to receive weather data, which can make a short-term change of the cleaning plan necessary.

If the further autonomous unit is a mop or a vacuum cleaner, the evaluation software can be used to detect and determine in the area of the data processing unit over which period of time and in which area of the building the respective cleaning devices were in use. In this way, the cleaning service provider can prove to the client that the commissioned cleaning tasks have been carried out properly.

Preferably, the data processing unit comprises a data memory for storing the supplied data. The data memory can be used, for example, to store data that exceeds the data required for the current cleaning task. These data can contain, for example, the data of a plurality of previous cleaning activities, so that statistical evaluations are possible on the basis of the data, with the help of which the cleaning activities can be optimized. Thus, it can be detected, for example, by how much the cleaning frequency in the entrance area to the street increases if, in winter, an increased dirt load occurs from outside into the object to be cleaned due to the obligation to grit. It can also be detected with the help of autonomous units having sensors that certain parts of the building are less heavily frequented and that the cleaning cycles are adapted accordingly.

The data stored in the data memory can either be evaluated in the data processing unit of the cleaning device or also or it can be read out and evaluated by a central evaluation unit via a data interface preferably provided for the transmission of data to an external reader. The transmission of the data between the cleaning device and an external reader is preferably wireless.

According to one preferred embodiment of the invention, the evaluation software accesses work plans stored electronically in a data memory of the cleaning device. The working plans are thereby preferably programmable and consequently adaptable to changing requirement profiles as well as the object to be cleaned.

According to a preferred embodiment of the cleaning system according to the invention, a plurality of signal transmitters are present which establish a wireless connection with the cleaning device if the cleaning device is within the range of the signal transmitter of an autonomous unit. For example, the autonomous units send push messages to the cleaning device via the signal transmitters after a wireless connection has been established following an authentication routine. In this way, the user of the cleaning device can obtain, via the output unit, information regarding those autonomous units that are permanently installed in the object which are close to the user. In this way the user can be informed about exactly those cleaning tasks or the instruction not to carry out normal cleaning tasks. Due to the near field communication, the instructions refer to cleaning tasks that are not only in the user's area of responsibility, but rather also in the immediate vicinity of the location of the cleaning device, which is usually the cleaning trolley.

Preferably, the number of movements or operations is thereby transmitted, which are detected by the autonomous units by means of the sensor system and counted up until the input of a suitable reset command. Therefore, the movements or operations detected and accumulated with the help of the sensor system must be stored in the autonomous units until the cleaning device comes within the range of the autonomous unit, a data connection has been established, and the stored number is sent to the receiving device of the cleaning device. The operation detected by the sensor system can be both mechanical as well as electrical in nature. Individual events can be detected, for example, the mechanical opening of a door, the switching on or off of a light in a certain room or the operation of a toilet flush. However, it can also be can also be integrated over time periods such as, for example, the water flow through a drinking water dispenser or the time period over which a room air conditioner is operated in order to determine in the data processing unit the correct time for maintenance work, such as the replacement of a drinking water cartridge or an air filter in the air conditioner.

Preferably, the sensor system detects a movement or operation above a certain trigger threshold. The trigger threshold must be defined individually. The autonomous units are then attached to selected objects which can provide relevant data for planning the cleaning. Subsequently, on the basis of learned profiles from the sensor system, only those profiles that are similar to the learned profile are interpreted as a trigger events. The simplest case is thereby an application of force, as can be detected on doors, cabinet doors, toilet lids, soap dispensers or towel dispensers, as soon as they are above a predefined trigger threshold.

Preferably the autonomous units can be adhered to an object. In this way, the cleaning system can be installed as easily as possible without interfering with the existing infrastructure. Due to the simple adhesion, there is no mechanical or electrical interference with the object.

According to a preferred embodiment of the invention, the cleaning system according to the invention comprises at least one further, second cleaning device which collects data as a mobile autonomous unit. Unlike the autonomous units permanently installed in the object to be cleaned, the second cleaning devices are cleaning devices carried by the user, such as a mop holder or vacuum cleaner. By detecting and accumulating data from the second cleaning devices as a mobile autonomous unit, the cleaning device can retrieve the data from the at least one second cleaning device via the receiving device and thus detect whether and how often the second cleaning device was in motion.

The cleaning device according to the invention can furthermore be linked with Personal Digital Assistants (PDAs) of the individual users so that they do not have to carry the cleaning trolley into all areas of the building and can still constantly receive information and/or handling instructions. The PDAs can also be used to confirm the execution of certain activities after each activity has been carried out via a touchpad provided on the PDA. Since each user carries a personalized PDA with them, it is also possible to carry out an assignment between the cleaning devices and the user, but it can also be established which user confirms the proper performance of a certain cleaning task.

The autonomous units or at least one of the autonomous units can be a beacon, tracker or fitness tracker. The technologies are already well known and standardized, and are characterized by a low power consumption. The power supply of the autonomous units essentially occurs via batteries which rarely need to be replaced due to the low energy consumption. The energy transmission should also be carried out with low energy, whereby the Bluetooth Low Energy (BLE) technology can be used, which works in a very energy-saving manner. Alternatively, other possible standards can also be considered, such as Bluetooth smart technology or communication with passive components, such as passive HF RFID tags, which are also frequently used and standardized.

### BRIEF DESCRIPTION OF THE DRAWINGS

The following figures show

FIG. 1 schematically a cleaning device that communicates with an autonomous unit permanently installed in the object to be cleaned; and

FIG. 2 shows a cleaning device which according to a preferred embodiment of the invention, is additionally in data exchange with a further autonomous unit.

### DETAILED DESCRIPTION OF THE PREFERRED EMBODIMENTS

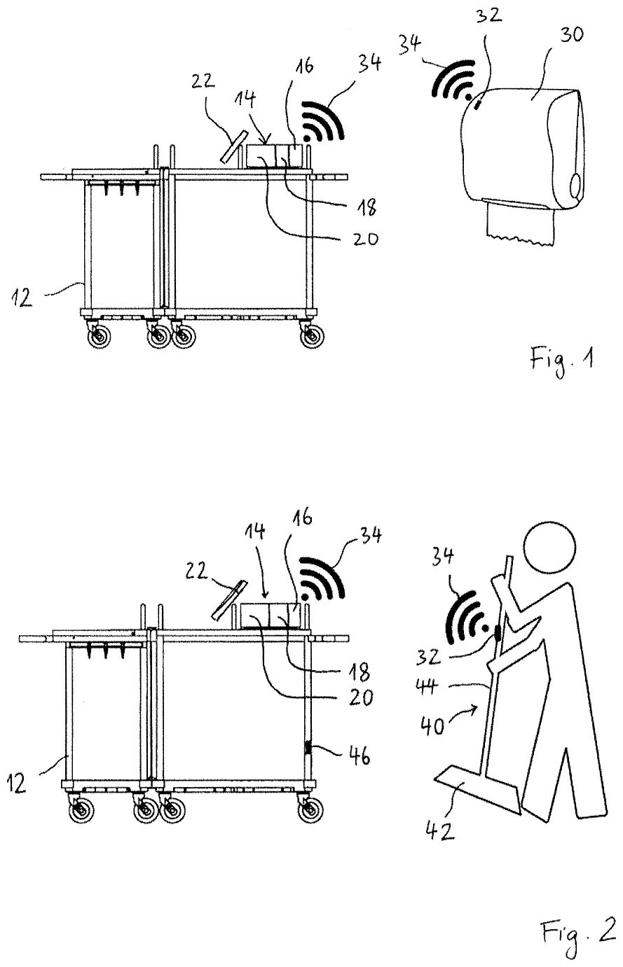

In FIG. 1, a cleaning trolley 12 is schematically shown which represents the cleaning device for an object to be cleaned, carries various further cleaning devices, and is moved by a user through the object to be cleaned. In the cleaning trolley 12 there is a computer unit 14 which comprises a receiving device 16, a data acquisition unit 18, a data processing unit 20 as well as an output unit in the form of a display. In the present case, the autonomous unit permanently installed in the object to be cleaned is formed as a towel dispenser which has an electronic component 32 which can contact and communicate with the receiving device 16 of the cleaning trolley via a near-field communication 34.

Within the towel dispenser 30, the electronic component 32 is functionally linked to the operation of the towel dispenser, for example by counting the number of operations that can be transmitted to the cleaning trolley via near-field communication. The number of activations detected by the receiving device 16 in the present embodiment example is fed to the data acquisition device 18 and in turn to the data processing unit 20. In the data processing unit 20, a comparison can be made with the information stored therein, after how many activations the paper supply in the towel dispenser 30 is to be refilled. Via the output unit 22, the user can be informed if and when this is likely to be the case. In this case, the user could decide whether a refilling of the paper stack or the use of a new paper roll is necessary before the next cleaning cycle. In the same way, however, the data processing unit may also issue specific instructions for action via the output unit 22, which give instructions to the user and leave no discretion in assessing the situation.

In the present example, if the user has been informed that a new roll is to be inserted into the towel dispenser, the user may simultaneously enter via the output unit 22 that this activity has been performed after the activity has been performed. A touchpad is suitable for this purpose, which enables both the function of the output unit 22 and the acceptance of inputs by the user.

The electronic component 32 can preferably be a beacon which in turn contains software that records the vibration of the towel dispenser housing by means of acceleration sensors (not shown) and uses a compare pattern to determine whether this is an operation of the towel dispenser. The value is stored in the beacon and can be transmitted to the cleaning trolley for further evaluation as described above.

The compare pattern shall be made for each autonomous unit permanently installed in the building and the electronic components, such as the beacon described above, shall be placed in a suitable location. The advantage of a beacon is that no constructive modification of the towel dispenser or another autonomous unit is required. For example, a beacon can also be attached to a door, which makes it possible to see how often the door has been operated, from which conclusions can be drawn about the frequency of washrooms or also meeting rooms.

In the embodiment according to FIG. 2 there is a further autonomous unit 40 in the form of a mop 42 which is moved by a schematically depicted user. In the handle 44 of the mop 42 there preferably is in turn an electronic component 32 configured as a beacon, which comprises an integrated software. Via the sensors and the software, the beacon determines whether it is in motion or not. The computer unit 14 in the cleaning trolley 12 evaluates this information as described above and can thus determine how long the autonomous unit 40 has been used.

In the case of autonomous cleaning devices that are either in use or are carried in the cleaning trolley 12, the computer unit 14 must be able to differentiate whether the autonomous unit itself is in motion or is only moved together with the trolley. This adjustment can be carried out in different ways. In the most general case, there is an additional motion sensor 46 on the cleaning trolley 12. As soon as the beacon 32 transmits a motion pattern to the computer unit 14, which corresponds to the motion pattern detected by the motion sensor 46, this motion of the mop 42 is suppressed since it was not in the cleaning operation. Another possibility in the case of certain cleaning devices is also to identify the specific cleaning patterns of these cleaning devices. Thus, for example, a further motion sensor can be located on the handle of a mop at a distance from the electronic component 32, and the typical handling of a mop can identified from the relative motion of the two motion sensors and distinguished from the transportation in a cleaning trolley.

The overall concept explained using simple embodiment examples can be as complex as desired with a corresponding number of sensors, evaluation tools and data stored in a memory of the computer unit. Thus, by a storing a precise cleaning plan, the cleaning staff can be provided with the area to be cleaned in a 3D view and the fastest route to the next cleaning location can be indicated within the framework of an indoor navigation. By means of a quick overview it can be displayed which rooms are still to be cleaned or have already been completed, or which rooms are not to be cleaned due to missing occupancy. For example, these can be meeting rooms that have not been occupied since the last cleaning, as can be established from a query about the operation of doors.

In the same way, however, it can also be documented that certain special activities have been carried out by means of indoor navigation, but also the operation of special autonomous cleaning devices, which can be used to prove that certain special tasks have been completed.

The evaluated data can also be used in the context of continuously performed cleaning processes in order to optimize cleaning processes and reconfigure them for individual users. In the same way, fault messages can be detected so that the building management is informed about the cleaning personnel which are located in all parts of the building during the cleaning processes, accepts fault messages and enters them into the system, which are automatically fed into a central system when approaching certain data communication nodes.

1. Cleaning system, comprising:
at least one autonomous unit permanently installed in an object, comprising a signal transmitter, a microchip as well as preferably a sensor system; and
a cleaning device for an object to be cleaned, the cleaning device comprising:
a receiving device that is configured to exchange data at close range with the autonomous unit permanently installed in the object to be cleaned and to receive data from the autonomous unit;
a data acquisition unit which is suited to acquire the data received from the receiving device and to supply it in an appropriate form to a data processing unit;
the data processing unit comprising evaluation software for processing the supplied data; and
a splash-proof output unit preferably comprising a display, and particularly preferably comprising a display with a touchscreen, the output unit being in an information connection with the data processing unit and being suited to output information and/or handling instructions to the user of the cleaning device.

2. Cleaning system according to claim 1,
wherein the cleaning device is a cleaning trolley preferably having at least one lockable wheel.

3. Cleaning system according to claim 1,
wherein the receiving device is additionally configured to exchange data with and to receive data from further autonomous units, the further autonomous units comprising a cleaning device.

4. Cleaning system according to claim 1,
wherein the data processing unit comprises a data memory for storing the supplied data.

5. A cleaning system according to claim 1 further comprising a data interface for transmitting the data to an external reader.

6. Cleaning system according to claim 1,
wherein the evaluation software accesses working plans stored electronically in a data memory of the cleaning device.

7. Cleaning system according to claim 1, further comprising an input device for data input by the user.

8. Cleaning system according to claim 1 further comprising a plurality of autonomous units having signal transmitters that are adapted to wirelessly connect to the cleaning device as soon as the cleaning device is respectively within the range of one of the signal transmitters, the signal transmitter sending messages to the cleaning device after a wireless connection has been established.

9. Cleaning system according to claim 1, at least one autonomous unit comprising a sensor system, the sensor system preferably numerically detecting, electronically processing and storing a movement or operation.

10. Cleaning system according to claim 8,
wherein the sensor system detects a movement or activation above a predetermined trigger threshold.

11. Cleaning system according to claim 1,
wherein the autonomous unit or at least one of the autonomous units can be adhered to an object.

12. Cleaning system according to claim 1,
wherein the cleaning system comprises at least one second cleaning device which collects data as a mobile autonomous unit.

13. Cleaning system according to claim 1, further comprising a Personal Digital Assistant which is able to be coupled to the cleaning apparatus.

14. Cleaning system according to claim 1,
wherein the at least one autonomous unit comprises a beacon, tracker, fitness tracker or a passive HF-RFID-TAG.
